(19) United States
(12) Patent Application Publication
(10) Pub. No.: US 2007/0070399 A1
(43) Pub. Date: Mar. 29, 2007

(54) FAX communication system

(75) Inventors: Yayoi Nakamura, Fukuoka (JP); Tomokazu Katsuro, Fukuoka (JP); Takayuki Tetsukawa, Fukuoka (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/371,690

(22) Filed: Mar. 9, 2006

(30) Foreign Application Priority Data
Sep. 28, 2005 (JP) JP 2005-281362

(51) Int. Cl. G06F 3/12

(52) U.S. Cl. 358/1.15; 358/400

(57) ABSTRACT

Disclosed is a FAX communication system for improving security and reliability of FAX communication. A FAX receiver receives FAX data and transmission source information. A transmission destination designation information acquisition section obtains transmission destination designation information during indirect communication of FAX data. A transmission destination number extraction section extracts stored and managed transmission destination numbers using the obtained information. An encryption processor extracts stored and managed serial numbers using the obtained information and encrypts identification data containing at least one of the transmission source information and serial number related to FAX data for transmission to generate encrypted data. An encrypted data attaching section attaches the encrypted data to FAX data for transmission to generate FAX data with encrypted data. A FAX transmitter transmits the FAX data with encrypted data to the transmission destination number. A decryption section receives the FAX data with encrypted data to decrypt the encrypted data.

### CROSS-REFERENCE TO RELATED APPLICATIONS

This application is based upon and claims the benefits of priority from the prior Japanese Patent Application No. 2005-281362, filed on Sep. 28, 2005, the entire contents of which are incorporated herein by reference.

### BACKGROUND OF THE INVENTION

1. Field of the Invention

The present invention relates to a FAX communication system. More particularly, the present invention relates to a FAX communication system for performing indirect communication of FAX (Facsimile) data.

2. Description of the Related Art

Recently, there is widely used a FAX server system in which a server collectively takes charge of storage and management of both transmit and receive FAX data so that a FAX operation can be performed not only from FAX devices but also from each client terminal on a LAN. Adoption of the FAX server system provides advantages that a plurality of FAX devices or lines are integrated so that reciprocating between the user's own seat and the FAX devices can be eliminated

Further, the FAX server system normally has a FAX wrong transmission preventive function. This function is a function for once receiving through a server a FAX for transmission and then transmitting the FAX only to destinations previously registered. Therefore, the FAX is prevented from being erroneously transmitted to an unregistered destination due to erroneous push of destination numbers accompanying the FAX transmission.

For conventional technologies for the FAX server system, there is proposed a method for specifying a FAX transmitter to prevent leakage of documents (see, e.g., Japanese Unexamined Patent Publication No. 2001-16423 (paragraph numbers [0022] to [0025], and FIG. 1)). Further, there is proposed a method for preventing parties interested in communication from denying communication facts (see, e.g., Japanese Unexamined Patent Publication No. 2003-143336 (paragraph numbers [0022] to [0026], and FIG. 1)).

However, the conventional FAX server system has no function for authentication of a transmission source even if having a function for preventing wrong transmission to a transmission destination. Therefore, there arise the following problems.

A FAX server side has no function for confirming a transmission source. Therefore, FAX transmitted from a FAX device other than a previously registered FAX device cannot be excluded.

A FAX server side does not perform acquisition and addition of transmission source information on FAX. Therefore, there is no means of communicating, to a FAX receiver, information on the transmission source of FAX.

There is no means of discriminating whether received FAX is transmitted through a FAX server.

It is difficult to confirm whether receive FAX data is replaced.

It is difficult to confirm whether receive FAX data is tampered with.

A transmission source number display of G3 FAX (analog telephone line FAX) is a text-based one and therefore, is easily imitated. As a result, it cannot be determined whether a FAX transmitter is proper.

### SUMMARY OF THE INVENTION

In view of the foregoing, it is an object of the present invention to provide a FAX communication system having a function for authentication of a transmission source, in which security and reliability are improved to allow high-quality FAX communication.

To accomplish the above object, according to the present invention, there is provided a FAX communication system for performing FAX communication. The FAX communication system comprises: a FAX server device, and a transmission destination user terminal, the FAX server device composed of: a transmission destination data storage section that stores and manages transmission destination designation information as information for designating a transmission destination of FAX data in relationship to a transmission destination number, a received FAX data storage section that stores and manages received FAX data in relationship to the transmission destination designation information and a serial number, a FAX receiver that receives FAX data and transmission source information, a FAX controller that includes a transmission destination designation information acquisition section for obtaining the transmission destination designation information during indirect communication of FAX data, a transmission destination number extraction section for extracting the stored and managed transmission destination number using the obtained transmission destination designation information, an encryption processor for extracting the stored and managed serial number using the obtained transmission destination designation information and for encrypting identification information containing at least one of the transmission source information and serial number related to FAX data for transmission to thereby generate encrypted data, and an encrypted data attaching section for attaching the encrypted data to FAX data for transmission to thereby generate FAX data with encrypted data, and a FAX transmitter that transmits the FAX data with encrypted data to the transmission destination number, the transmission destination user terminal including: a decryption section that receives the FAX data with encrypted data to decrypt the encrypted data, the transmission destination user terminal obtaining the transmission source information and the serial number in addition to FAX data.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a principle view of a FAX communication system.

FIG. 2 shows one example of stored information of a transmission destination data storage section.

FIG. 3 shows one example of stored information of a receive FAX data storage section.

FIG. 4 shows a constitution of an encryption processor.

FIG. 5 shows a registration example of a secret key storage section.

FIG. 6 shows a constitution of an encrypted data attaching section.

FIG. 7 shows a system configuration example of a FAX communication system.

FIG. 8 is a flowchart showing operations from FAX reception to transmission of a FAX server device.

FIG. 9 is a flowchart showing operations from FAX reception to decryption of a transmission destination user terminal.

FIG. 10 shows setting operations of transmission destination designation information by a voice response.

FIG. 11 shows an outline of a common public key cryptosystem.

FIG. 12 shows an outline of a digital signature using public key encryption.

FIG. 13 shows an example of FAX data with two-dimensional bar code.

FIG. 14 shows a flow from generation to transmission and decryption of FAX data with two-dimensional bar code.

FIG. 15 shows a modified example of a FAX communication system.

### DESCRIPTION OF THE PREFERRED EMBODIMENTS

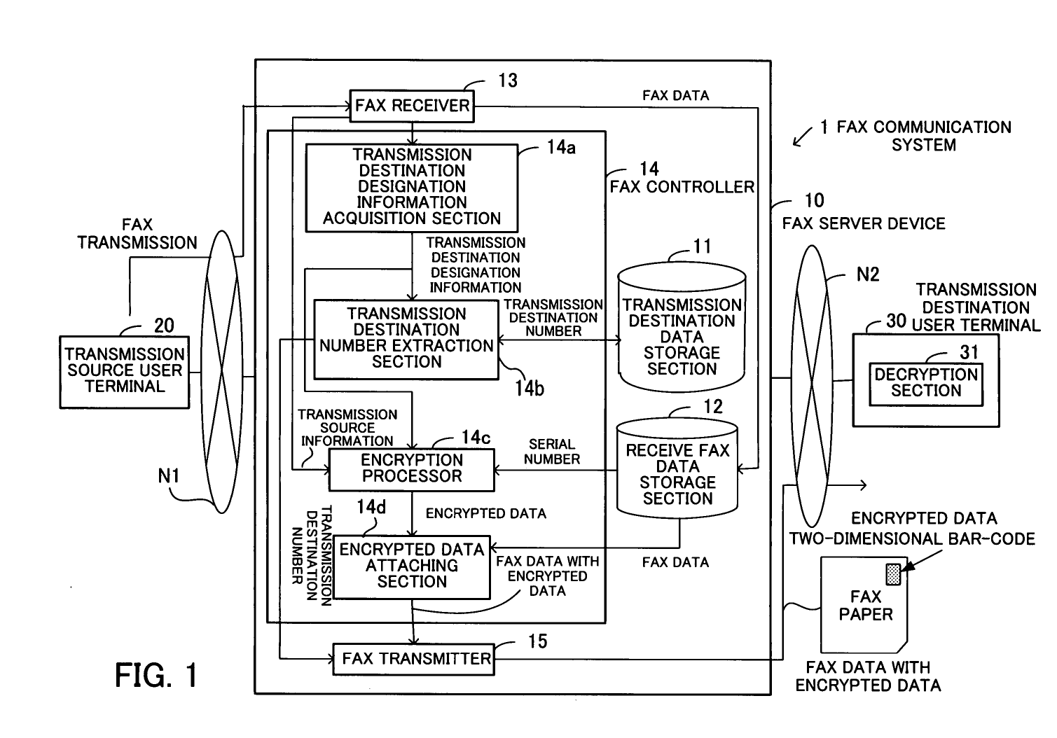

Preferred embodiments of the present invention will be described below with reference to the accompanying drawings, wherein like reference numerals refer to like elements throughout. FIG. 1 is a principle view of a FAX communication system. A FAX communication system 1 comprises a FAX server device 10, a transmission source user terminal 20 and a transmission destination user terminal 30. The system 1 is a system for performing FAX indirect communication (the transmission source user terminal 20 and the transmission destination user terminal 30 correspond to personal computers or FAX devices).

The transmission source user terminal 20 and the FAX server device 10 are connected through a network N1. The transmission destination user terminal 30 and the FAX server device 10 are connected through a network N2. Further, FAX data transmitted from the transmission source user terminal 20 is stored and managed by the FAX server device 10 and is transmitted to the transmission destination user terminal 30 from the FAX server device 10 (the FAX server device 10 can transmit directly a received FAX data to the transmission destination user terminal 30 as well as the device 10 can perform an image format conversion on the received FAX data and transmit the resulting FAX data information to the terminal 30, for example, in a mail form).

The FAX server device 10 is composed of a transmission destination data storage section 11, a receive FAX data storage section 12, a fax receiver 13, a fax controller 14 and a FAX transmitter 15.

The transmission destination data storage section 11 stores and manages transmission destination designation information as information for designating a transmission destination of FAX data in relationship to a transmission destination number. The receive FAX data storage section 12 stores and manages received FAX data in relationship to the transmission destination designation information and a serial number. The fax receiver 13 receives FAX data and transmission source information.

The fax controller 14 includes a transmission destination designation information acquisition section 14a, a transmission destination number extraction section 14b, an encryption processor 14c and an encrypted data attaching section 14d. The transmission destination designation information acquisition section 14a obtains the transmission destination designation information during indirect communication of FAX data. Using the obtained transmission destination designation information, the transmission destination number extraction section 14b extracts the transmission destination number stored and managed in the transmission destination data storage section 11.

The encryption processor 14c extracts, using the obtained transmission destination designation information, the serial number stored and managed in the receive FAX data storage section 12. Further, the section 14c encrypts identification data containing at least one of the transmission source information and serial number related to FAX data for transmission to thereby generate encrypted data.

The encrypted data attaching section 14d attaches the encrypted data to FAX data for transmission to thereby generate FAX data with encrypted data.

The FAX transmitter 15 transmits the FAX data with encrypted data to the transmission destination number. On the other hand, the transmission destination user terminal 30 includes a decryption section 31. The decryption section 31 receives the FAX data with encrypted data to decrypt the encrypted data.

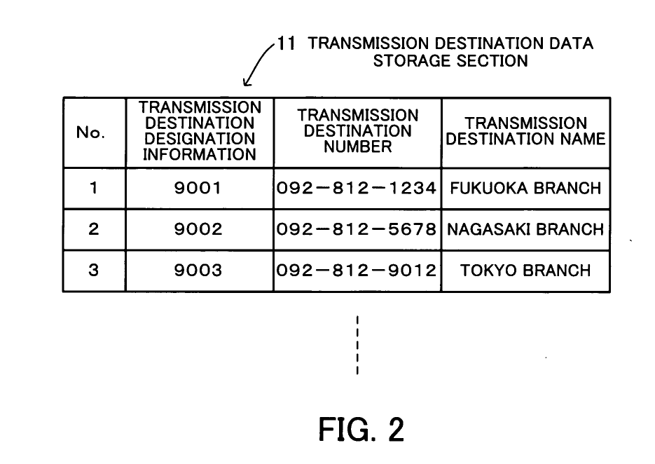

Next, stored information stored and managed in the transmission destination data storage section 11 and the receive FAX data storage section 12 will be described. FIG. 2 shows one example of stored information in the transmission destination data storage section 11. The transmission destination data storage section 11 makes a database of transmission destination designation information, a transmission destination number and a transmission destination name for the storage and management. The transmission destination designation information is represented by 4-digit code number in the figure and the transmission destination number is represented by a telephone number (the transmission destination number may be represented by an IP address). Thus, the section 11 stores the transmission destination designation information in relationship to the transmission destination number.

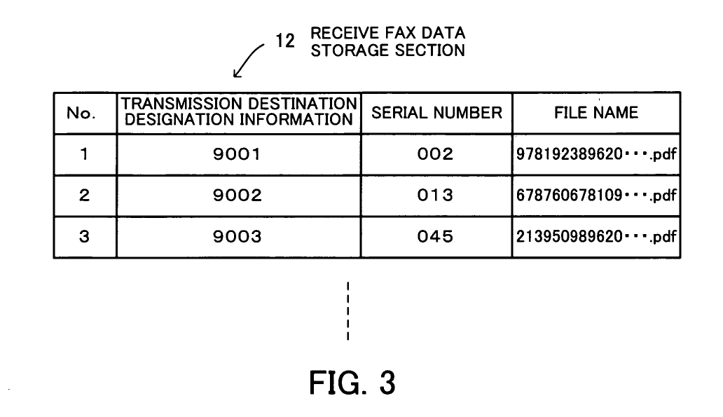

FIG. 3 shows one example of stored information in the receive FAX data storage section 12. The receive FAX data storage section 12 makes a database of transmission destination designation information, a serial number and a file name for the storage and management.

The serial number is a number indicating, by transmission destination, what number FAX data for transmission is now stored. For example, the serial number 13 of the code number 9002 indicates that a 13th FAX data for transmission to a transmission destination with the code number 9002 is now stored (in other words, twelve FAX data sheets are already transmitted to the transmission destination with the code number 9002). Further, the file name is a file name of FAX data. In an example of FIG. 3, the file name is stored and managed using a PDF file (the file name may be managed by a Tiff file).

FIG. 3 shows only a stored and managed condition of FAX data for transmission. In practice, the section 12 also stores FAX data transmitted in the past as well as transmission destination designation information or serial number in relation to the FAX data.

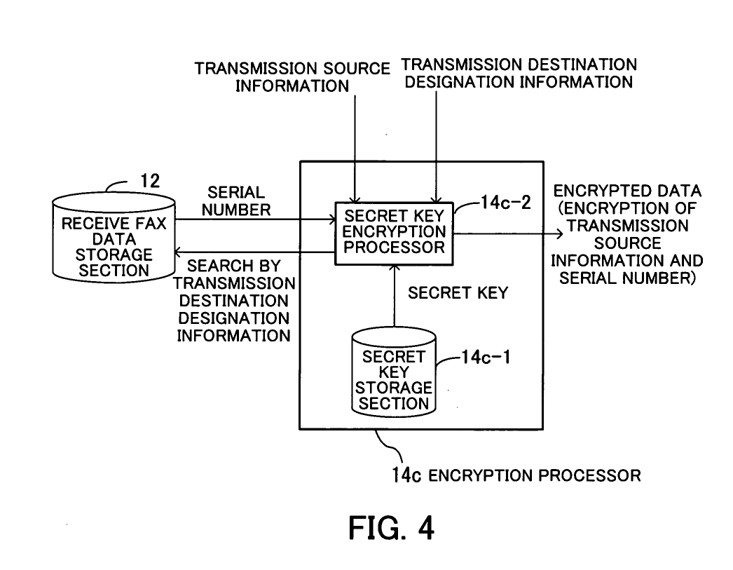

Next, each constitution of the encryption processor 14c and the encrypted data attaching section 14d will be described. FIG. 4 shows a constitution of the encryption processor 14c. The encryption processor 14c is composed of a secret key storage section 14c-1 and a secret key encryption processor 14c-2.

The secret key storage section 14c-1 stores a secret key corresponding to transmission destination designation information. Using the secret key corresponding to the transmission destination designation information on the FAX data for transmission, the secret key encryption processor 14c-2 encrypts transmission source information of the transmission source user terminal 20 and a serial number of the FAX data to thereby generate encrypted data.

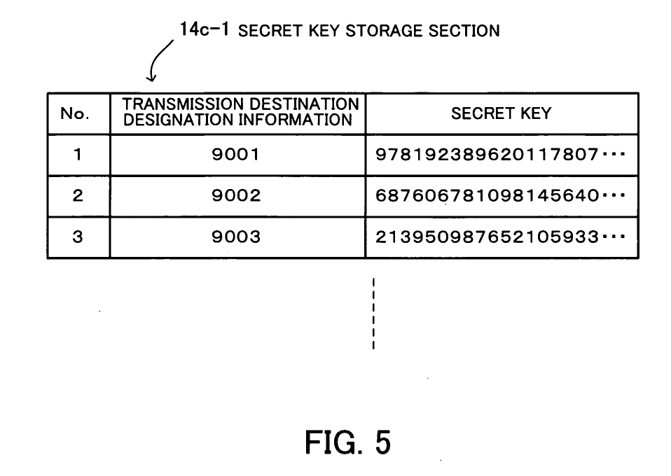

FIG. 5 shows a registration example of the secret key storage section 14c-1. The secret key storage section 14c-1 stores and manages the secret key in association with the transmission destination designation information.

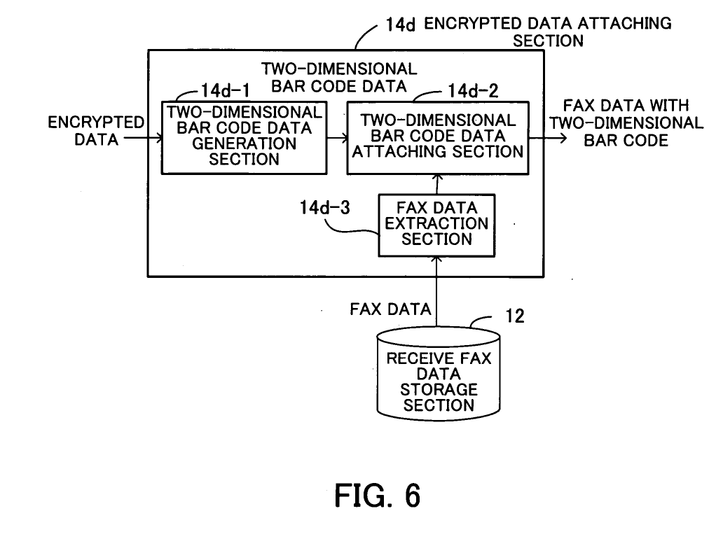

FIG. 6 shows a constitution of the encrypted data attaching section 14d. The encrypted data attaching section 14d is composed of a two-dimensional bar code data generation section 14d-1, a two-dimensional bar code data attaching section 14d-2 and a FAX data extraction section 14d-3.

The two-dimensional bar code data generation section 14d-1 converts encrypted data into two-dimensional bar code data (e.g., QR (Quick Response) code). The FAX data extraction section 14d-3 extracts, from the receive FAX data storage section 12, FAX data for transmission. The two-dimensional bar code data attaching section 14d-2 attaches the two-dimensional bar code data to the extracted FAX data to generate FAX data with encrypted data (hereinafter, referred to as “FAX data with two-dimensional bar code”).

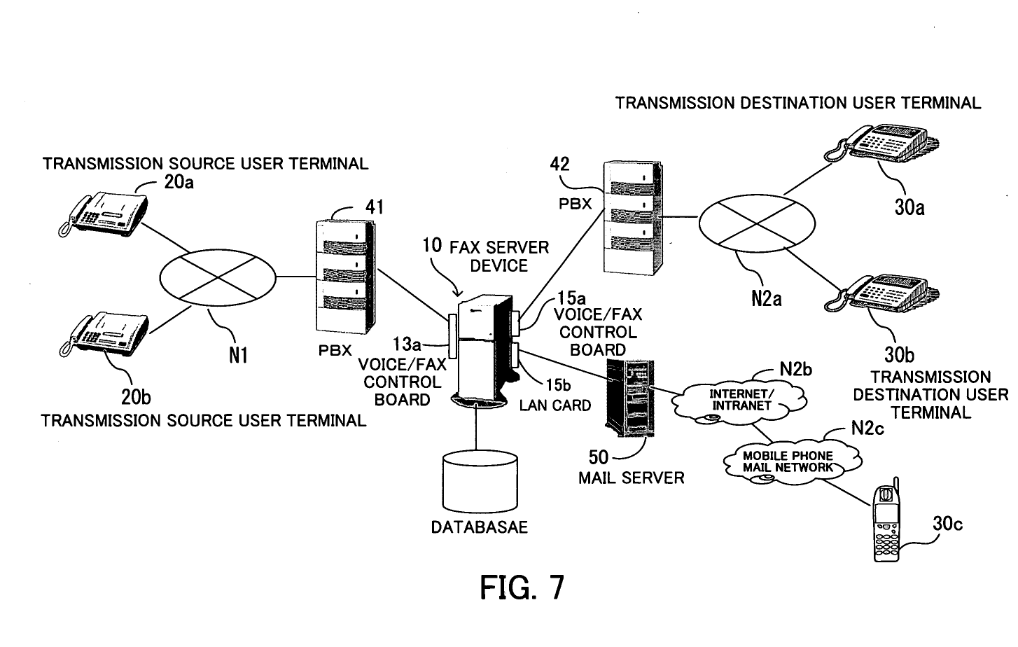

Next, a configuration example of a system to which the FAX communication system 1 is applied will be described. FIG. 7 shows a system configuration example of the FAX communication system 1. Connection relationship between respective constituent elements will be described. A network N1 connects transmission source user terminals 20a and 20b to a PBX41. The FAX server device 10 is connected to the PBX41 through a voice/FAX control board 13a (included in the FAX receiver 13). The FAX server device 10 has a database (DB: corresponding to the transmission destination data storage section 11 and the receive FAX data storage section 12).

A network N2a connects transmission destination user terminals 30a and 30b to a PBX42. The FAX server device 10 is connected to the PBX42 through a voice/FAX control board 15a (included in the FAX transmitter 15).

On the other hand, Internet/Intranet N2b and a mobile phone mail network N2c are connected to each other and the Internet/Intranet N2b is connected to a mail server 50. The FAX server device 10 is connected to the mail server 50 through a LAN card 15b (included in the FAX transmitter 15). Further, the mobile phone mail network N2c is connected to a transmission destination user terminal (mobile-phone handset) 30c.

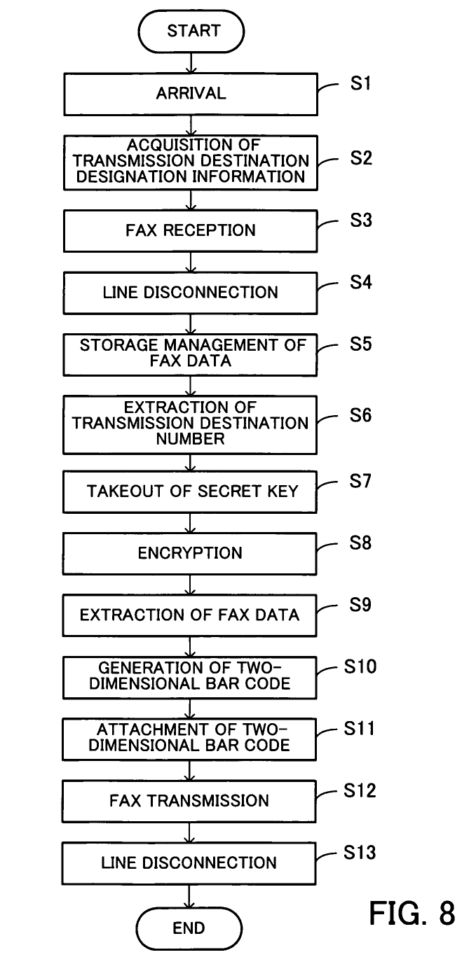

Next, operations from FAX reception to transmission in the FAX server device 10 will be described. FIG. 8 is a flowchart showing the operations from FAX reception to transmission in the FAX server device 10.

(Step S1) Arrival

The FAX receiver 13 detects an arrival and notifies the FAX controller 14 of the arrival.

(Step S2) Acquisition of Transmission Destination Designation Information

From an input of PB signals or a voice input using a voice response system such as IVR (Interactive Voice Response) performed on the transmission source user terminal 20 side, the transmission destination designation information acquisition section 14a obtains transmission destination designation information on FAX data.

(Step S3) FAX Reception

The FAX receiver 13 receives FAX data and transmission source information (a telephone number and name of the transmission source user terminal 20).

(Step S4) Line Disconnection

The FAX receiver 13 disconnects a line to the transmission source user terminal 20.

(Step S5) Storage Management of FAX Data

The receive FAX data storage section 12 stores and manages the received FAX data in relationship to the transmission destination designation information and the serial number.

(Step S6) Extraction of Transmission Destination Number

During FAX transmission, the transmission destination number extraction section 14b searches, using as a key the transmission destination designation information, information stored in the transmission destination data storage section 11 to thereby extract a transmission destination number of the transmission destination user terminal 30. Herein, when unable to extract the transmission designation number using the obtained transmission destination designation information, the section 14b considers that the information is wrong (the FAX transmitter is not proper) and stops FAX communication control.

(Step S7) Takeout of Secret Key

In the encryption processor 14c, the secret key encryption processor 14c-2 takes out a secret key corresponding to the transmission destination designation information using the secret key storage section 14c-1.

(Step S8) Encryption

Using the transmission destination designation information, the secret key encryption processor 14c-2 extracts a serial number stored and managed in the receive FAX data storage section 12. Further, using the secret key taken out, the section 14c-2 encrypts the transmission source information and the serial number to thereby generate encrypted data.

(Step S9) Extraction of FAX Data

In the encrypted data attaching section 14d, the FAX data extraction section 14d-3 extracts FAX data for transmission from the receive FAX data storage section 12 using as a key the transmission destination designation information.

(Step S10) Generation of Two-Dimensional Bar Code

The two-dimensional bar code data generation section 14d-1 two-dimensional bar-codes contents of the encrypted data.

(Step S11) Attachment of Two-Dimensional Bar Code

The two-dimensional bar code data attaching section 14d-2 attaches the generated two-dimensional bar code data to a predetermined position of the extracted FAX data to thereby generate FAX data with two-dimensional bar code.

(Step S12) FAX Transmission

Based on the transmission destination number, the FAX transmitter 15 transmits the FAX data with two-dimensional bar code to the transmission destination user terminal 30.

(Step S13) Line Disconnection

After the FAX transmission, the FAX transmitter 15 disconnects a line to the transmission destination user terminal 30.

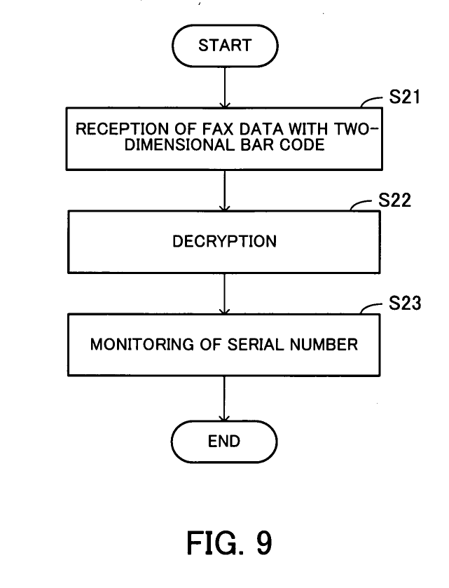

Next, operations from FAX reception to decryption in the transmission destination user terminal 30 will be described. FIG. 9 is a flowchart showing the operations from FAX reception to decryption in the transmission destination user terminal 30.

(Step S21) Reception of FAX Data with Two-Dimensional Bar Code

The transmission destination user terminal 30 receives the FAX data with two-dimensional bar code.

(Step S22) Decryption

The decryption section 31 reads out the two-dimensional bar code data attached to the FAX data and decrypts the bar code data using a public key previously given. Thus, the terminal 30 obtains the transmission source information of the transmission source user terminal 20 and the serial number of the FAX data.

(Step S23) Monitoring of Serial Number

The decryption section 31 automatically monitors the serial number obtained by performing decryption. When numbers are skipped or repeated, the section 31 recognizes that normal transmission is not performed. At this time, the transmission destination user terminal 30 raises an alarm.

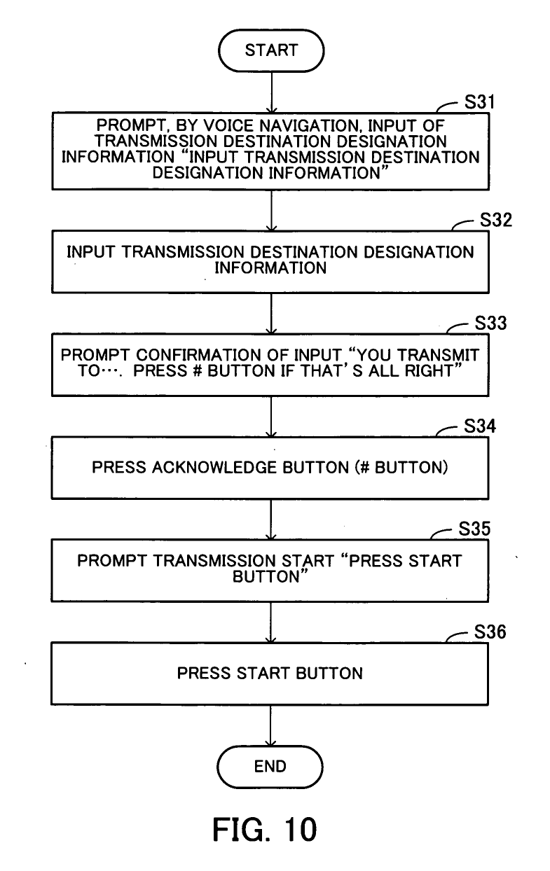

Next, setting operations of the transmission destination designation information by a voice response will be described. FIG. 10 shows the setting operations of the transmission destination designation information by a voice response. More specifically, FIG. 10 shows a condition where the transmission destination designation information is transmitted from the transmission source user terminal 20 to the FAX server device 10 using a voice response system.

(Step S31) By voice navigation of the voice response system, the transmission source user terminal 20 prompts the transmission source user to input the transmission destination designation information.

(Step S32) In accordance with the voice navigation, the transmission source user inputs, as the transmission destination designation information, the code number as described in FIG. 2.

(Step S33) By the voice navigation, the transmission source user terminal 20 prompts the transmission source user to confirm the input.

(Step S34) The transmission source user presses an acknowledge button (a # button).

(Step S35) By the voice navigation, the transmission source user terminal 20 prompts the transmission source user to start transmission.

(Step S36) The transmission source user presses a start button.

In this example, the transmission source user inputs the code information in accordance with voice navigation. Further, in accordance with the voice navigation by a telephone installed at the transmission source user terminal 20, the user gives by voice the transmission destination designation information (for example, the user gives by voice a transmission destination name of the FAX using as a name the transmission destination designation information), whereby the user can also input the transmission destination designation information.

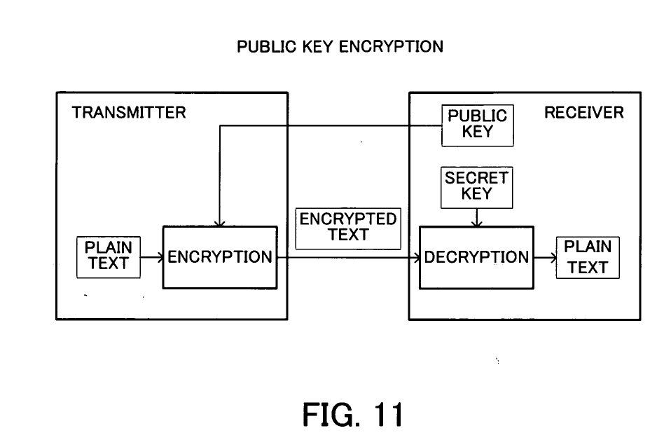

Next, an outline of a public key cryptosystem used in encryption processing of the FAX communication system 1 will be described. FIG. 11 shows an outline of a common public key cryptosystem. In the public key cryptosystem, two different keys are used. The two keys are normally referred to as a public key and a secret key.

The public key and the secret key are inverse functions of each other. A text encrypted by the public key can be decrypted by the secret key, whereas a text encrypted by the secret key can be decrypted by the public key.

A receiver creates a pair of the public key and the secret key to allow anyone to read the public key. A transmitter creates an encrypted text using as an encrypting key a public key of the receiver and transmits the encrypted text to the receiver. The receiver decrypts the received encrypted text using as a decrypting key a private secret key to obtain an original plain text.

Herein, it is difficult to calculate a secret key from a public key. Therefore, even if encrypting a plain text by a public key, it is difficult to obtain a secret key. In a common key cryptosystem, a key must be safely shared between exchangers of information. Therefore, a key must be changed for each communication partner. On the other hand, in a public key cryptosystem, one encrypting key may be just opened in each receiver. Therefore, a receiver can receive an encrypted message also from a person with whom the receiver has never communicated. The public key cryptosystem is widely applied to cipher communication as well as a digital signature or user authentication.

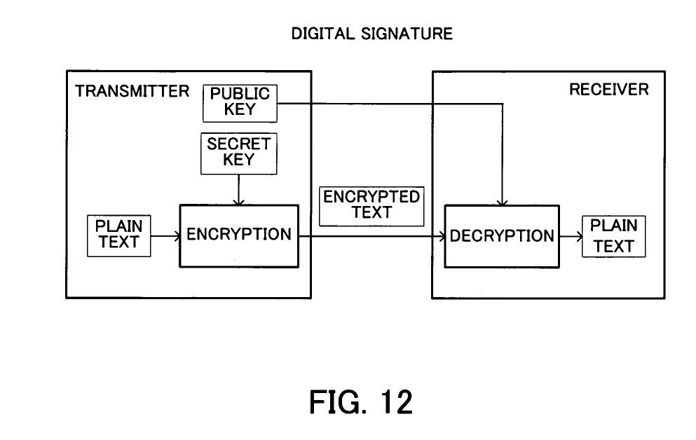

In the encryption processing of the FAX communication system 1, there is used a public key cryptosystem employing, particularly, procedures of the digital signature using public key encryption. FIG. 12 shows an outline of a digital signature using the public key encryption. The digital signature means encrypted signature information attached for vouching for the validity of digital documents. By the public key cryptosystem, the signature certifies a preparer of the documents as well as vouches that the documents are not tampered with.

Further, in the digital signature, a method of encrypting the whole message may be used. However, when encrypting the whole message, the amount of processing becomes large and therefore, a method of encrypting only a message creator (referred to as a message digest) is also used. That is, a transmitter transmits a message in a plain text as well as transmits a message digest encrypted using a secret key to a receiver. The receiver receives the message in the plain text and decrypts the message digest by a public key to thereby recognize that the message is transmitted from a proper document creator. In the FAX communication system 1, a message corresponds to FAX data, and transmission source information and a serial number correspond to a message digest.

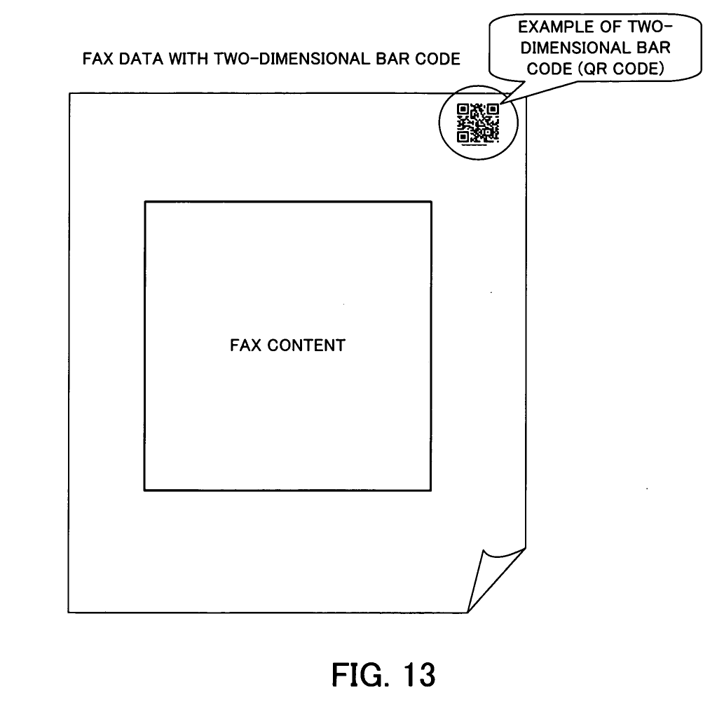

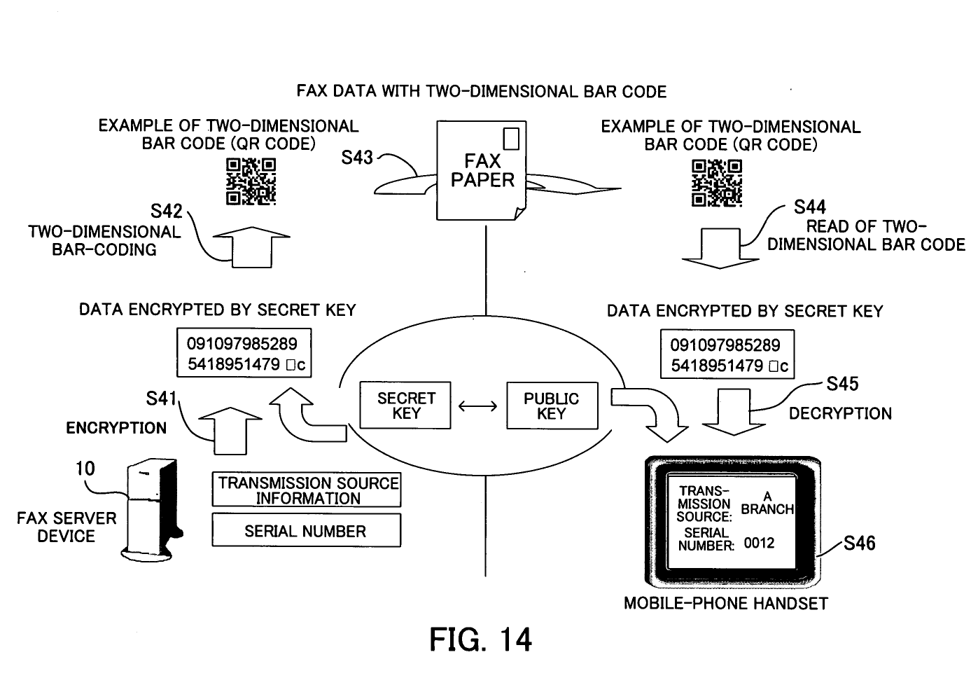

Next, an example of FAX data with two-dimensional bar code and a flow from generation to decryption of the FAX data with two-dimensional bar code will be described with reference to FIGS. 13 and 14.

FIG. 13 shows the example of FAX data with two-dimensional bar code. A two-dimensional bar code is attached to a predetermined position of FAX data. FIG. 14 shows the flow from generation to transmission and decryption of the FAX data with two-dimensional bar code.

(Step S41) The FAX server device 10 encrypts transmission source information and a serial number using a secret key to thereby generate encrypted data.

(Step S42) The FAX server device 10 two-dimensional bar-codes the encrypted data and attaches the resulting two-dimensional bar code data to FAX data.

(Step S43) The FAX server device 10 transmits the FAX data with two-dimensional bar code to a transmission destination.

(Step S44) The transmission destination user terminal 30 receives the FAX data with two-dimensional bar code and reads out the two-dimensional bar code data.

(Step S45) The transmission destination user terminal 30 decrypts the two-dimensional bar code data using a public key.

(Step S46) The transmission destination user terminal 30 displays, on a screen, contents of the FAX data as well as the decrypted transmission source information and serial number.

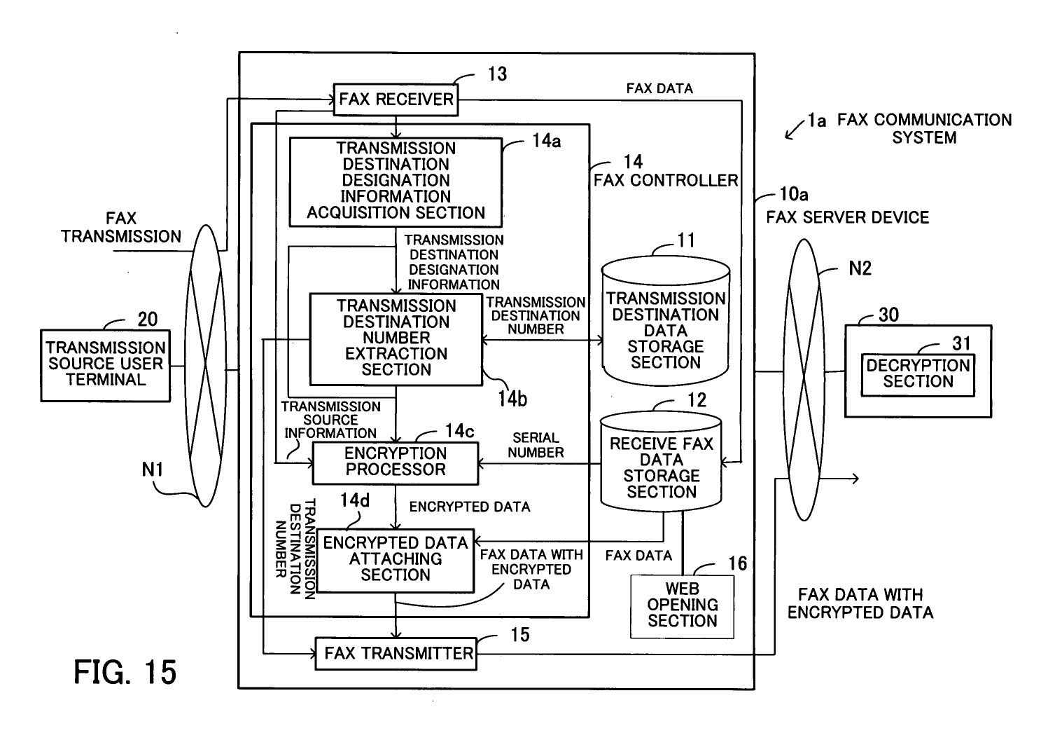

Next, a modified example of the FAX communication system 1 will be described. FIG. 15 shows the modified example of a FAX communication system. A FAX communication system 1a has a renewed FAX server device 10a. The FAX server device 10a has a WEB opening section 16 (the other configuration of the system 1a is the same as that in FIG. 1).

The WEB opening section 16 accesses a WEB server (not shown) and opens, on the WEB through the network N2, information stored in the receive FAX data storage section 12. The transmission destination user terminal 30 makes WEB access using the transmission source information and serial number obtained by decrypting the two-dimensional bar code. Thus, the FAX information stored in the receive FAX data storage section 12 is browsed on the WEB.

By taking the above-described configuration, FAX paper transmitted to the transmission destination and FAX contents opened on the WEB are compared, so that it can be surely confirmed whether the FAX data are transmitted from a proper transmission source.

As described above, according to the present invention, the FAX server device 10 encrypts the transmission source information and serial number related to FAX data for transmission to thereby generate encrypted data. Further, the device 10 two-dimensional bar-codes the encrypted data and attaches the resulting two-dimensional bar code data to the FAX data. Then, the FAX server device 10 transmits the FAX data with two-dimensional bar code to a transmission destination. The transmission destination user terminal 30 receives the FAX data with two-dimensional bar code. Then, the terminal 30 decrypts the two-dimensional bar code data to obtain the transmission source information and the serial number in addition to the FAX data. Therefore, as compared with a conventional FAX server system, the present invention can provide effects as described below. That is:

When being unable to search the transmission destination number using the transmitted transmission destination designation information, the FAX server device 10 stops FAX communication control. Therefore, FAX transmitted from a transmission source other than a proper transmission source can be excluded.

By checking the presence of the two-dimensional bar code on the FAX paper received by the transmission destination, it can be discriminated whether the FAX is transmitted from a proper transmission source through the FAX server device 10.

By attaching the FAX-related transmission source information to the FAX paper using the two-dimensional bar code and decrypting the bar code, it can be discriminated which transmission source transmits the FAX.

By attaching, to the FAX paper using the two-dimensional bar code, the FAX-related serial number stored and managed in the FAX server device 10, it can be discriminated what number FAX is transmitted from the transmission source.

The transmission destination user terminal 30 side performs automatic monitoring of the serial number. Therefore, it can be discriminated whether improper multiple transmission is performed or the FAX paper tampered with by cut-and-pasting the two-dimensional bar code is transmitted.

In a transmission source number display using the two-dimensional bar code, the transmission source is hardly tampered with as compared with a simple text-based transmission source number display.

In the FAX communication system 1, a secret key is used to generate the encrypted data and the transmission destination side uses a public key to decrypt the encrypted data and therefore, management of the key is easy. For example, in a case of using a mobile-phone handset for performing decryption, even if losing the handset, the transmission destination side may require another public key again and therefore, is largely unaffected.

Using the transmission source information and serial number obtained by decrypting the two-dimensional bar code data, WEB access is made and FAX information opened up on the Internet is browsed (the transmission source information and serial number obtained by decrypting the two-dimensional bar code serve as, for example, a password. Therefore, when the transmission source information and the serial number are unavailable by decrypting the two-dimensional bar code data, no FAX information can be browsed. Accordingly, only a FAX receiver who can decrypt the two-dimensional bar code can browse the FAX information). Therefore, propriety of the FAX data transmission source can be more surely recognized.

In the FAX communication system of the present invention, the FAX server device encrypts the transmission source information and serial number related to FAX data for transmission to thereby generate encrypted data. Further, the device attaches the encrypted data to the FAX data to generate FAX data with encrypted data. Then, the FAX server device 10 transmits the FAX data with encrypted data to a transmission destination. The transmission destination user terminal receives the FAX data with encrypted data. Then, the terminal decrypts the encrypted data to obtain the transmission source information and the serial number in addition to the FAX data. Thus, encrypted information on authentication of the transmission source is given to the transmission destination. As a result, security and reliability of FAX communication are improved and therefore, high-quality FAX communication can be performed.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A FAX communication system for performing FAX communication, comprising:
a FAX server device, and
a transmission destination user terminal,
the FAX server device composed of:
a transmission destination data storage section that stores and manages transmission destination designation information as information for designating a transmission destination of FAX data in relationship to a transmission destination number,
a receive FAX data storage section that stores and manages received FAX data in relationship to the transmission destination designation information and a serial number,
a FAX receiver that receives FAX data and transmission source information,
a FAX controller that includes a transmission destination designation information acquisition section for obtaining the transmission destination designation information during indirect communication of FAX data, a transmission destination number extraction section for extracting the stored and managed transmission destination number using the obtained transmission destination designation information, an encryption processor for extracting the stored and managed serial number using the obtained transmission destination designation information and for encrypting identification data containing at least one of the transmission source information and serial number related to FAX data for transmission to thereby generate encrypted data, and an encrypted data attaching section for attaching the encrypted data to FAX data for transmission to thereby generate FAX data with encrypted data, and
a FAX transmitter that transmits the FAX data with encrypted data to the transmission destination number,
the transmission destination user terminal including:
a decryption section that receives the FAX data with encrypted data to decrypt the encrypted data, the user terminal obtaining the transmission source information and the serial number in addition to FAX data.

2. The FAX communication system according to claim 1, wherein the encryption processor encrypts the identification data by a secret key to generate the encrypted data and the decryption section decrypts the encrypted data using a public key, whereby the transmission destination user terminal obtains the transmission source information and the serial number.

3. The FAX communication system according to claim 2, wherein the encryption processor two-dimension bar-codes the encrypted data encrypted using the secret key and the encrypted data attaching section attaches the two-dimension bar-coded encrypted data to FAX data.

4. The FAX communication system according to claim 1, wherein when the decryption section automatically monitors the serial number obtained by decrypting the encrypted data and recognizes that normal transmission is not performed, the transmission destination user terminal raises an alarm.

5. The FAX communication system according to claim 1, wherein the FAX server device further comprises a WEB opening section that opens, on the WEB, information stored in the receive FAX data storage section and the transmission destination user terminal makes WEB access using the transmission source information and serial number obtained by decrypting the encrypted data, whereby information stored in the receive FAX data storage section is browsed on the WEB.

6. A FAX server device for performing FAX communication, comprising:
a transmission destination data storage section that stores and manages transmission destination designation information as information for designating a transmission destination of FAX data in relationship to a transmission destination number,
a receive FAX data storage section that stores and manages received FAX data in relationship to the transmission destination designation information and a serial number,
a FAX receiver that receives FAX data and transmission source information,
a FAX controller that includes a transmission destination designation information acquisition section for obtaining the transmission destination designation information during indirect communication of FAX data, a transmission destination number extraction section for extracting the stored and managed transmission destination number using the obtained transmission destination designation information, an encryption processor for extracting the stored and managed serial number using the obtained transmission destination designation information and for encrypting identification data containing at least one of the transmission source information and serial number related to FAX data for transmission to thereby generate encrypted data, and an encrypted data attaching section for attaching the encrypted data to FAX data for transmission to thereby generate FAX data with encrypted data, and
a FAX transmitter that transmits the FAX data with encrypted data to the transmission destination number.

7. A FAX communication method for performing FAX communication using a FAX server device and a transmission destination user terminal, the FAX server device having a transmission destination data storage section and a receive FAX data storage section, the method comprising the steps of:
storing and managing, by the transmission destination data storage section, transmission destination designation information as information for designating a transmission destination of FAX data in relationship to a transmission destination number,
storing and managing, by the receive FAX data storage section, received FAX data in relationship to the transmission destination designation information and a serial number,
receiving FAX data and transmission source information,
obtaining the transmission destination designation information during indirect communication of FAX data,
extracting the stored and managed transmission destination number using the obtained transmission destination designation information,
extracting the stored and managed serial number using the obtained transmission destination designation information,
encrypting identification data containing at least one of the transmission source information and serial number related to FAX data for transmission to thereby generate encrypted data,
attaching the encrypted data to FAX data for transmission to thereby generate FAX data with encrypted data,
transmitting the FAX data with encrypted data to the transmission destination number, and
receiving the FAX data with encrypted data and decrypting the encrypted data to obtain the transmission source information and the serial number in addition to FAX data.

8. The FAX communication method according to claim 7, wherein the identification data is encrypted using a secret key to generate the encrypted data and the encrypted data is decrypted using a public key, whereby the transmission destination user terminal obtains the transmission source information and the serial number.

9. The FAX communication method according to claim 8, wherein the encrypted data encrypted using the secret key is two-dimension bar-coded and the two-dimension bar-coded encrypted data is attached to the FAX data.

10. The FAX communication method according to claim 7, wherein when automatically monitoring the serial number obtained by decrypting the encrypted data and recognizing that normal transmission is not performed, the transmission destination user terminal raises an alarm.

11. The FAX communication method according to claim 7, wherein the FAX server device further has a WEB opening function for opening, on the WEB, information stored in the receive FAX data storage section and the transmission destination user terminal makes WEB access using the transmission source information and serial number obtained by decrypting the encrypted data, whereby information stored in the receive FAX data storage section is browsed on the WEB.
